(19) United States
(12) Patent Application Publication
(10) Pub. No.: US 2012/0303431 A1
(43) Pub. Date: Nov. 29, 2012

(54) Method and System for Establishing an Electronic Consumer-Merchant Forum with Efficient e-Coupon Access and Redemption

(75) Inventors: Chaney J. Phillips, Maumelle, AR (US); Daniel K. Alexis, El Dorado, AR (US); Gabriel D. Mayes, Little Rock, AR (US)

(73) Assignee: REVOLUTION BUSINESS SOLUTIONS, Little Rock, AR (US)

(21) Appl. No.: 13/114,623

(22) Filed: May 24, 2011

(51) Int. Cl. G06Q 30/00

(52) U.S. Cl. 705/14.22

(57) ABSTRACT

A merchant forum system is described that comprises a system of servers and databases connected to a network that can host a platform of merchants and facilitate electronic commerce between merchants and consumers. A merchant creates and stores a merchant profile and e-coupon campaign on the merchant forum system via a computer connected to the network. A consumer member accesses the merchant forum system to locate merchants and e-coupons offers via a computer or mobile device connected to the network. The merchant forum system passes data to a consumer member's mobile device representing an authentic e-coupon image having a moving image portion to permit expedient authentication and execution of transactions. A time limit on execution of the transaction and redemption of the authentic e-coupon image provides additional security.

### FIELD OF THE DISCLOSURE

The present disclosure generally relates to facilitating electronic commerce via a merchant forum and use of electronic coupons (e-coupons), and more particularly relates to facilitated access to and redemption of e-coupons.

### BACKGROUND

Recent developments in the evolution of social networking systems have included the introduction of services such as Twitter®, Facebook®, and LinkedIn® among others. These services provide users with an ability to share information with multiple individuals and to broadcast information about themselves and their goings-on. Multi-media information can be transmitted via a multitude of electronic data methods to mobile devices, computers, and other electronic means to alert other users of changes to information for the broadcaster of the information.

The transmission of information often takes place across a network that can include the Internet which connects servers and databases containing information of individuals and organizations. Multi-media and other types of information may be searched or individuals and organizations may benefit from a “push” of information that a software algorithm determines pertains to the individual or organization.

It would be beneficial in electronic commerce to directly connect consumers with merchants offering electronic coupons (e-coupons) in a forum. It would be further beneficial in commerce for a system to facilitate efficient redemption of e-coupons by consumers.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an embodiment of a network including servers, personal computer, and mobile devices that may be used to perform the methods and implement the merchant forum system described herein;

FIG. 2 is one embodiment example of graphical user interface display illustrating an example merchant forum menu with e-coupon selection options;

FIG. 3 is an example display showing an embodiment of an authenticated e-coupon image for redemption;

FIG. 4 is a flow chart illustrating one embodiment of creating a merchant forum directly between merchants and consumer members;

FIG. 5 is a flow chart detailing one embodiment of a process for becoming a consumer member, accessing merchant e-coupon offers, and redeeming e-coupons; and

FIG. 6 is a block diagram illustrating an embodiment of a server or computer system architecture that may be used to perform the methods and implement the merchant forum system described herein.

### DETAILED DESCRIPTION OF THE DRAWINGS

A merchant forum system is described that comprises a system of servers and databases connected to a network that can host a platform of merchants and facilitate electronic commerce between merchants and consumers. A merchant creates and stores a merchant profile and e-coupon campaign on the merchant forum system via a computer connected to the network. A consumer member accesses the merchant forum system to locate merchants and e-coupons offers via a computer or mobile device connected to the network. The merchant forum system passes data to a consumer member's mobile device representing an authentic e-coupon image having a moving image portion to permit expedient authentication and execution of transactions. A time limit on execution of the transaction and redemption of the authentic e-coupon image provides additional security.

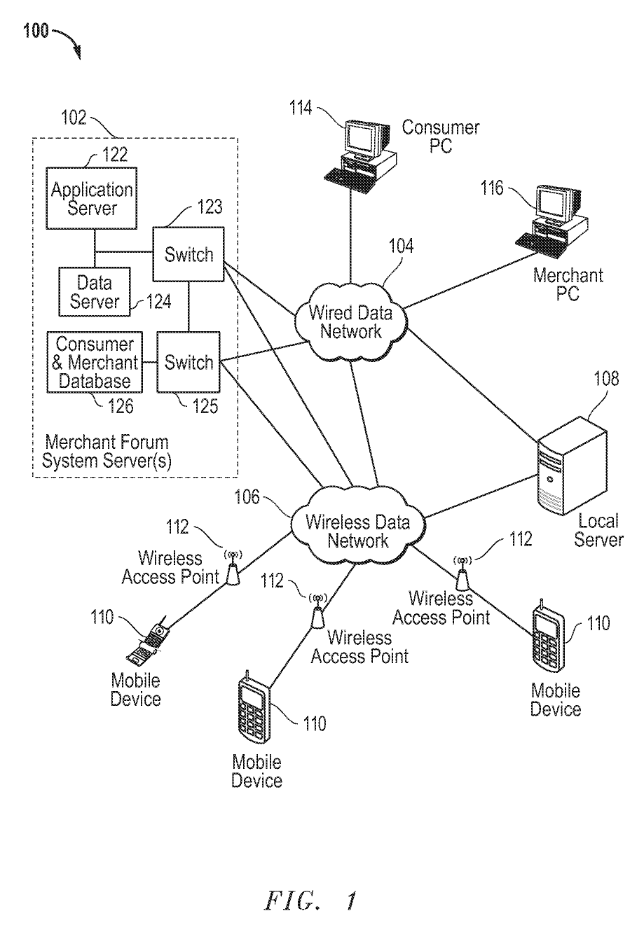

The merchant forum system interfaces with a network, such as the Internet, that may include wired and wireless portions. FIG. 1 shows a block diagram for a network system 100 for use in connection with the merchant forum system and e-coupon redemption process according to one embodiment. The system 100 includes a set of servers 102 including a consumer and merchant database 126, and a wired data network 104. The set of servers 102 with database 126 are coupled to the wired data network 104 via a switch or switches 123 and 125 or some other interface. The set of servers including 122 and 124 and database 126 host at least portions of the merchant forum system 102 described above. The merchant forum system described is implemented in software running on the computer hardware that comprises the servers and the database depicted at 102. The servers 102 are coupled to a wired data network 104 that can be a global network, a wide area network, a local area network or other version of network. In an example, the wired data network can include all or some portion of the Internet. It also may be coupled to a wireless network 106. The wireless network 106 can include one or more of the following well known networks: WiFi networks, WiMAX networks, Bluetooth networks, WiLAN networks, CDMA, TDMA, or other types of cellular networks. The wireless system can include a local server 108 that can couple the wired data network with the wireless network. The wireless network may couple the wired network with one or more mobile devices 110 via wireless access points 112. A consumer member computer 114 and a merchant computer 116 may be coupled to wired data network 104 or alternatively to the wireless data network 106 (not shown).

A merchant profile is stored in the consumer and merchant database 126, also referred to as the merchant forum system database. The merchant forum system database 126 is controlled and administered by the servers 102 which host the merchant forum system. While some data and webpage information may be stored or cached in other locations during operation, e.g. a local server 108 of a content delivery network, the merchant forum system is generally hosted on one or more origin servers 102 connected to a computer network 104.

The merchant forum system may provide a preset software form to the computer 116 or mobile system of the merchant in one embodiment. Using such a form, the merchant creates the merchant profile. Data input into the preset form includes fields such as merchant name, locations, telephone numbers, brief descriptions of products and services offered, terms of the e-coupons to be offered, and other information. The merchant profile data is received by the servers 102 hosting the merchant forum system. For example, the merchant profile data form can be received in an HTML file format or other similar data file for storage in the merchant forum system database 126. The merchant profile data may include a variety of merchant profile information such as merchant logos, photographs, trademarks, or other information. This information may be input or attached to the merchant profile form upon submission by the merchant or added at a later time. Each merchant that submits profile information to the merchant forum system is assigned a unique merchant identification number.

Additionally, the merchant profile may include a variety of specific parameters set for any e-coupons to be offered. In an embodiment, an e-coupon campaign form may be part of the preset merchant form, or it may be a separately sent data form received at the servers 102 hosting the merchant forum system. E-coupon parameters can include terms of the offer, expiration dates, status of the consumer permitted to access the e-coupon, time permitted to redeem the e-coupon, allowances to extend redemption time, number of available redemptions, appearance of the e-coupon image, and other features.

A consumer may access the merchant forum system hosted on a set of servers 102 via the networks 106 and 104. The consumer may access the system servers 102 via a mobile device 110 or another computing device 114. The consumer may become a consumer member by creating a consumer profile. In an alternative embodiment, the consumer may need to pay a subscription fee in addition to submitting a consumer profile to become a consumer member. The subscription fee may be recurring. The consumer member profile data is sent in an HTML or similar type file to be saved in the merchant forum system database at the set of servers hosting the merchant forum system. Each consumer member that submits profile information to the merchant forum system is assigned a unique consumer member identification number.

The merchant forum data may be displayed to the consumer in a menu. Some or all of the data input into the merchant profile form may be included for display. A non-limiting example of the merchant forum menu may be organized in a variety of ways including alphabetically and chronologically by e-coupon posting (or reverse-chronological order). The merchant forum menu may be categorized by product, by service, or by geographic location. This merchant forum menu provides a beneficial direct link between a consumer and a participating merchant. The merchant forum system permits a consumer to conduct a targeted search of merchants and e-coupons. The merchant forum system avoids the case of a generalized search where the information desired may or may not be yielded. For less well-known brands such as regional businesses, the merchant forum system mitigates a risk that the business and its e-coupon offers are overlooked or ignored for the simpler consumer search task of searching nationally-known brands in a generalized search. Moreover, nationwide merchants may also seek to gain better penetration in local markets via a direct access forum. The merchant forum system may be set up to be regionally specific. The direct link of the merchant forum system makes consumer interaction as easy and efficient as possible in the stages of locating merchants, finding the e-coupons, and redeeming the e-coupons.

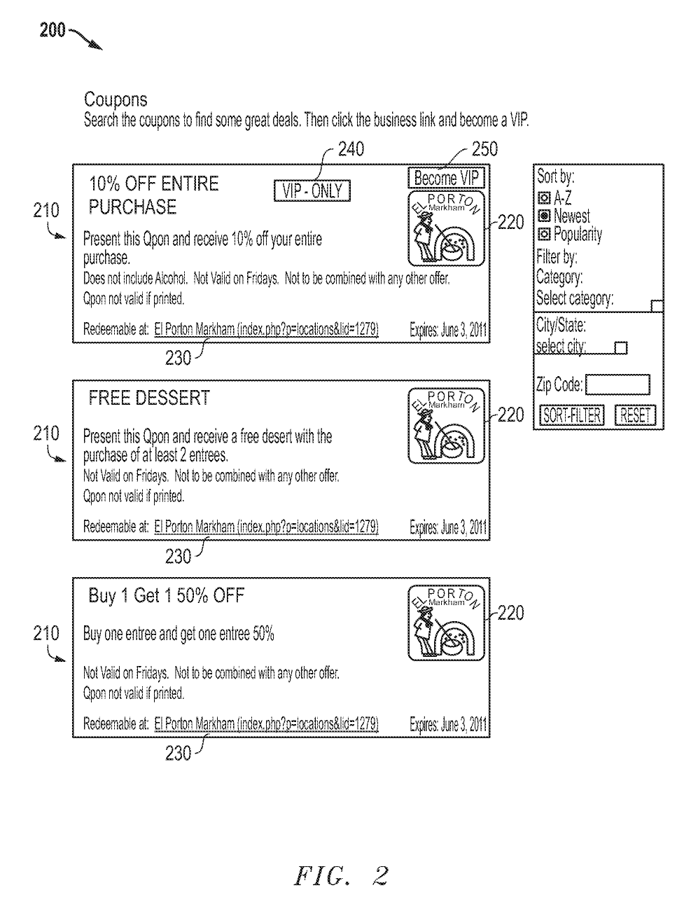

FIG. 2 shows an embodiment of a displayed merchant forum menu 200. The display may include various e-coupon types 210 offered by the merchant; VIP, loyal customer, or generally available e-coupons. The e-coupon image 210 displayed in the menu of merchants 200 for the merchant forum can take a variety of forms. For example, a VIP e-coupon may be depicted as grayed out if the consumer member viewing the merchant profile has not elected VIP status with that merchant. Alternatively, an ordinary e-coupon may appear active and in full color or active by depicting it in full color or in some other manner and may be accessed by a consumer member visiting the merchant's profile. In another alternative, a loyal customer e-coupon may be grayed out and unavailable to a regular viewer who has not yet elected to become a consumer member in the merchant forum.

The e-coupon image 210 for the menu 200 may be stored in the merchant forum database 126. The e-coupon image 210 is normally associated with the given merchant with some depiction on the e-coupon image of the merchant's name and mark or logo as shown at 220 in FIG. 2. The e-coupon image 210 may include merchant profile information and links to additional merchant information 230. It may even include a link to a merchant website. Alternatively, the e-coupon image may be depicted alongside the merchant's name and profile, or may be accessed by a button or icon linking to the merchant e-coupons.

In the described embodiment of FIG. 2, the merchant forum 200 is shown displaying e-coupons 210 in reverse-chronological order based on posting date and time to the merchant forum system. In one embodiment, the displayed merchant menu includes a button 220 or icon type display containing an image or words depicting the trademark name or insignia of the merchant. It is meant for some or all of the merchant profile data in the forum of merchants to be displayed in an easily-accessible format. This can include links to additional information about specific merchants or e-coupons as shown at 230. The displayed merchant forum menu allows the consumers to quickly drill down and identify a merchant of interest and directly access the merchant's e-coupon offers and information. It establishes direct and easy to use link between consumers seeking e-coupons and merchants seeking to attract consumers by offering e-coupons.

The described embodiment includes an indication of the status-level required for a consumer to utilize the e-coupon as depicted in FIG. 2 at 240. The displayed menu of merchants also includes an icon or button 250 to permit a consumer member to elect VIP status with respect to that particular merchant.

The consumer member redeems an e-coupon electronically. This can happen in a variety of ways. In an embodiment, the consumer member redeems the e-coupon on a mobile device. The mobile device may be running a mobile application. The consumer member indicates an intent to redeem an e-coupon by touching the image, touching a button, or swiping a bar on the mobile device. Alternatively, for VIP members who have elected to receive electronic notifications of e-coupon offers, the notification may include a button, icon, or other functional input capable of indicating an intent to redeem the offered e-coupon.

When redemption of an e-coupon is elected by a consumer member, redemption intent data is sent from the consumer member's mobile device or personal computer to the servers hosting the merchant forum system. In response to receiving the redemption intent data from the consumer member, the servers of the merchant forum system may, in certain embodiments, send a verification page to the consumer member seeking confirmation that the consumer member intends to redeem the merchant's e-coupon. The page sent by the merchant forum servers can include instructions on how to specifically redeem the e-coupon. The verification page may also indicate the numbers of remaining available redemptions for the given e-coupon. The verification page may also indicate the redemption time limitation in seconds, minutes or even hours. In other embodiments, the verification page sent may provide the option to call off the redemption of the e-coupon or postpone redemption of the e-coupon to another time.

The e-coupon is pulled from the merchant forum database 126 and the unique consumer member identification number is associated with the e-coupon. The unique association of the consumer member with the e-coupon is logged into the database 126 in the merchant forum system 100. The consumer member data is updated with information about date and time of redemption, business information, and other variables.

An authenticated e-coupon image is sent to the consumer member's mobile device 110 which will display an image of the e-coupon. The e-coupon image data includes information identifying the merchant, identifying the e-coupon offer, and contains animation data. Some portion of the authenticated e-coupon image is constantly moving when displayed on the consumer member's mobile device 110. The moving portion of the authenticated e-coupon image is an animation using HTML 5, CSS, JavaScript, Flash® or a similar software type with animation capabilities. The moving portion prevents unauthorized duplication of the authenticated e-coupon image. In an alternative embodiment, the moving portion of the authenticated e-coupon image is changeable. For example, the animation used may rotate from among a selection of moving image portions. The selected animation may become part of the uniquely-associated e-coupon for the consumer member. It may be unique to each consumer member. The animation may also change according to which merchant issued the coupon or how much time remains in the count-down limit. For example, as time counts down, the moving portion may move faster or slower until time has expired. The moving portion of the authenticated e-coupon image may move continuously during redemption. Alternatively, the moving portion may move continuously for some portion of the redemption period that is not the entire redemption period but greater than.

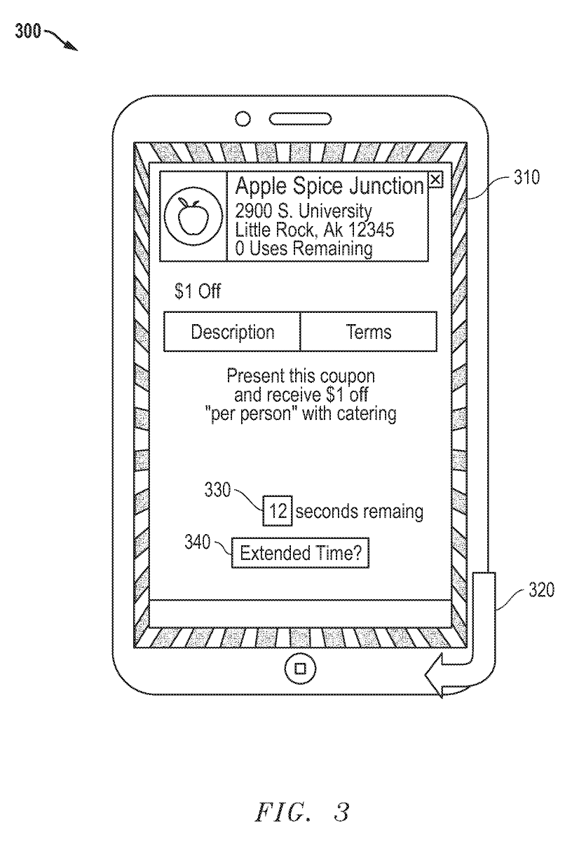

In an embodiment depicted in FIG. 3, the e-coupon image describing the merchant's offer appears in the center of the authenticated e-coupon image 300. The background or border 310 of the authenticated e-coupon image is a constantly moving image. It can be a spinning or spiraling background 320. Alternatively, some other form of moving image portion can be used. The background of the image 310 is an animation that runs on the mobile device type. The moving portion is only animated after the consumer member has elected to redeem the e-coupon. The moving background 320 of the image in the embodiment indicates authentication of the e-coupon image to the merchant. Displaying the moving image ensures that the e-coupon is not being easily duplicated, for example, by a “screen shot” of the same e-coupon image that can be repeatedly redeemed without merchant authorization.

In an alternative embodiment of the authenticated e-coupon image, the moving portion or some part of the moving portion of the authenticated e-coupon image may include a countdown timer 330. The countdown timer 330 sets a limit on how long the consumer member will have to actually redeem the e-coupon with the merchant. Upon expiration of time, the merchant forum system no longer permits the authenticated e-coupon image to be displayed. For example, the merchant forum system may send data to cancel the authenticated e-coupon image on the consumer member's mobile device. Alternatively, the authenticated e-coupon display data sent to the mobile device may include commands executed after countdown that no longer permit display of the authenticated e-coupon image after time has expired.

Once the timer has run out, the authenticated e-coupon image and the uniquely associated e-coupon data for that consumer member will be designated as “used” or “redeemed” in the merchant forum system. The authenticated e-coupon image may be displayed as “used” or “redeemed.” Similarly, the e-coupon image may be displayed on the merchant forum menu as “used” or “redeemed.”

In an alternative embodiment, the authenticated e-coupon image may include an icon or button permitting the consumer member to extend the prescribed count-down time limit one or more times 340. Data from such a request is sent back to the merchant forum system and causes the countdown timer to be reset at the merchant forum system servers. Additionally, the authenticated e-coupon image 300 display data may be modified to reflect the change in the countdown timer setting 340.

To prevent counterfeiting by recording the authenticated e-coupon image and playing back the recording to a merchant during an unauthorized redemption, the authenticated e-coupon 300 has active features. The description button 350 and terms button 360 may be used as an additional form of security. As displayed in FIG. 3, the description is shown. If the terms button is touched, the text changes to reflect terms of the e-coupon. Terms may be specified by the merchant. Example terms can include limitations on the e-coupon, for example the e-coupon is not valid if printed or may not be combined with other offers. Alternatively, the merchant may ask the consumer member to depress an authenticate button 370. The authenticate button 370 may alter the colors or text of the authentic e-coupon image. Alternatively, the authenticate button 370 may add another different moving image portion or alter the existing moving image portion. For example, in FIG. 3, depressing the authenticate button 370 may reverse the spinning direction 320 of the background or border 310 of the authenticated e-coupon image 300.

In the described embodiment, the merchant forum system may permit a merchant to limit the number of redemptions an individual consumer member may make of a given e-coupon offer. The merchant forum system servers track the number of redemptions and may, in certain alternative embodiments, display the number of redemptions made by a given consumer member. After the limited number of redemptions has been reached by a consumer member, the particular e-coupon which has been uniquely associated with the consumer member may no longer available for redemption by that consumer member. An attempt to redeem a particular e-coupon may also be rejected by the merchant forum system if the set limit on redemptions has been reached.

E-coupons offer merchants a way to attract business from consumers and build allegiance from consumers. In an embodiment of the invention, it is beneficial not to require the merchant to provide feedback to the merchant forum system servers about the redemption of the authenticated e-coupon image. Requiring e-coupon validation by having a merchant cross-reference a number or enter feedback to the e-coupon system creates an unwieldy redemption procedure. Hassles during redemption may discourage consumers from taking advantage of the e-coupons and can even cause consumers to abandon visiting the merchant in the first place. The redemption process of the described embodiments streamlines the commercial transaction by avoiding delay or complication in executing the transaction. Moreover, the merchant need not review or verify any specific redemption number in a database of numbers when validating the authenticated e-coupon image. Instead, the merchant may trust that the e-coupon image is authenticated because of the moving background behind the image of the merchant's e-coupon.

Further security comes from the very limited amount of time permitted for redemption. The time limit is different from a common expiration date of the overall e-coupon offer. The countdown timer 330 permits redemption of the authenticated e-coupon image in a preferably short time period. Seconds, minutes, or hours is most preferred, but a few days is also possible and contemplated. The short time period adds an additional layer of security to thwart the chances of counterfeiting the e-coupon. Either or both of the moving background or time limit vastly reduce the chances that the authenticated electronic e-coupon image is counterfeit. At the same time, the method described herein does not slow down the commercial transaction. The described embodiment avoids potential annoyance by the consumer due to delay. It also avoids creating the belief that the merchant cannot trust the consumer that may arise with a long verification process. By avoiding these disadvantages, the merchant can eliminate reconsideration of the transaction by the consumer. The described embodiment provides for a more efficient, but still secure, way for redeeming e-coupons by consumer members than otherwise available.

Additional security measures can be implemented along with the disclosed embodiment. The merchant forum system may send the authenticated e-coupon image 300 with an authenticate button 370 to the consumer member mobile device. The authenticate button 370 can alter the authenticated e-coupon image upon request by the merchant as described above. Depressing the authenticate button 370 or, alternatively a description 350 or terms button 360, shows that the authenticated e-coupon image is active and not simply a counterfeit recording. In an alternative embodiment, depressing the authenticate button 370 may also send a confirmation request to the set of servers hosting the merchant forum system. The merchant forums system may return a confirmation message to the consumer member's mobile device. The consumer member may show the confirmation message to the merchant.

Other additional security measures can include implementation of validation numbers or validation barcodes on the authenticated electronic e-coupon image. With such an additional feature, a merchant with serious suspicions of a fraud may choose to double-check the redemption process by cross-checking with a database at the merchant forum system. The merchant forum system may be accessed by the merchant via a computer or mobile device or a barcode reader connected to the same. However, an efficient redemption process that is still secure can be achieved with the authenticated e-coupon image having a time limitation 330, a moving background 310 or other moving image portion, and/or an active authenticate button 370 for regular transactions.

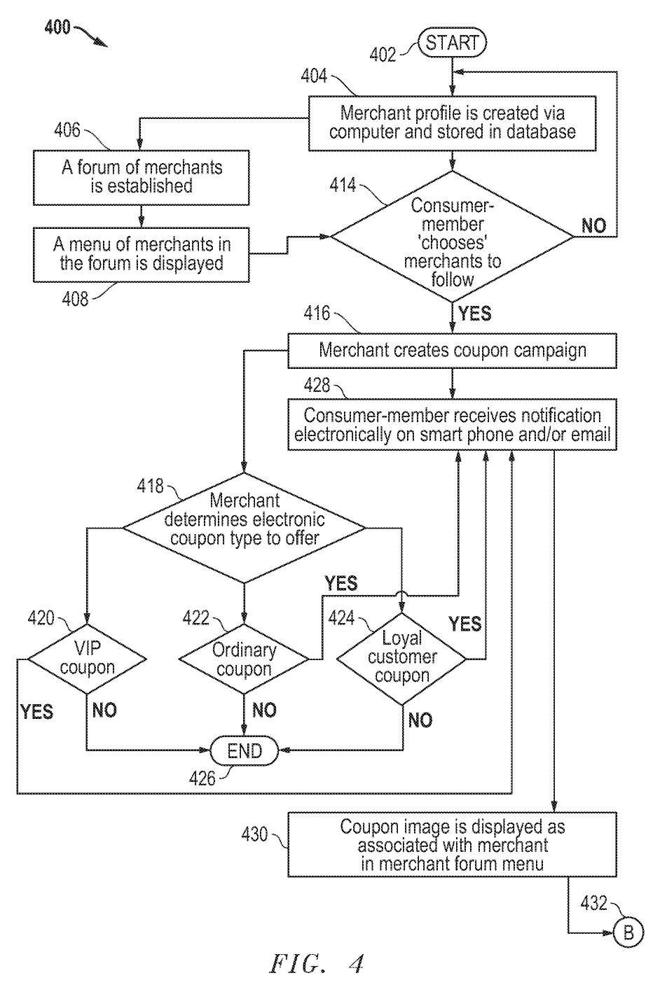

FIG. 4 shows a flow chart illustrating the exemplary method of creating a direct forum between merchants and consumer members. The forum enables a consumer to directly search for and access e-coupon offerings from merchants who have established membership with the forum. The process 400 begins at 404 where a merchant profile is created via computer and merchant profile data is sent to a set of servers hosting the forum.

The process continues at 406, where the merchant profile data or e-coupon campaign data is added to the merchant forum system database. The forum of merchants included in this database may be organized and displayed in any number of ways.

At 408, the set of servers hosting the merchant forum send display data to a mobile device or other computing device of a consumer member.

At 414 of the process depicted in FIG. 4, a consumer member elects VIP status with a particular merchant thereby providing permission for the merchant forum to present up to the minute information with respect to e-coupon offers established by that merchant. The election of VIP status by the consumer member is stored in the database among the servers hosting the merchant forum system.

At 416, FIG. 4, the merchant may elect to create a new e-coupon campaign. The merchant may use an e-coupon campaign form to input data into an HTML or other data file and set the parameters described above for the e-coupon. The e-coupon campaign form data file is received at the set of servers hosting the merchant forum at 416 of FIG. 4.

The merchant may select from one of at least three types of e-coupons to make available to consumers 418. At 420, the first type of e-coupon a merchant may elect is a VIP e-coupon which is only available to consumer members who elect VIP status to follow a particular merchant. At 422, the second type of e-coupon that may be created by the merchant using the e-coupon form is an ordinary e-coupon available to any consumer member who chooses to access the merchant forum website whether or not that consumer member has elected VIP status with respect to the merchant. A third potential e-coupon type that a merchant may elect to create for its e-coupon campaign is a loyal customer e-coupon. At 424 in the described embodiment, the loyal customer e-coupon can be made available to consumer members including those electing VIP status with a merchant. The loyal customer e-coupon enables the merchant forum system to track the number of e-coupon redemptions by a consumer member. When a certain number of e-coupon redemptions are achieved by a consumer member, the merchant may offer an additional promotional deal.

Upon receipt of the data establishing the merchant's e-coupon campaign, the merchant forum system automatically notifies VIP consumer members of the newly-offered merchant e-coupons at 428 in FIG. 4. Notification can take place electronically via a push notification agreed to by the VIP consumer member. Examples of electronic notification include as an email, as an SMS text, or as a message received at an inbox made available to a consumer member when logging into his or her account on the merchant forum system.

At 430, the merchant forum system creates an e-coupon image to be displayed within the menu of merchants. The e-coupon image is associated with an issuing merchant and may indicate whether the e-coupon is offered only to VIP consumer members. Display of the e-coupon image in the menu of merchants is described in further detail above in the context of FIG. 2.

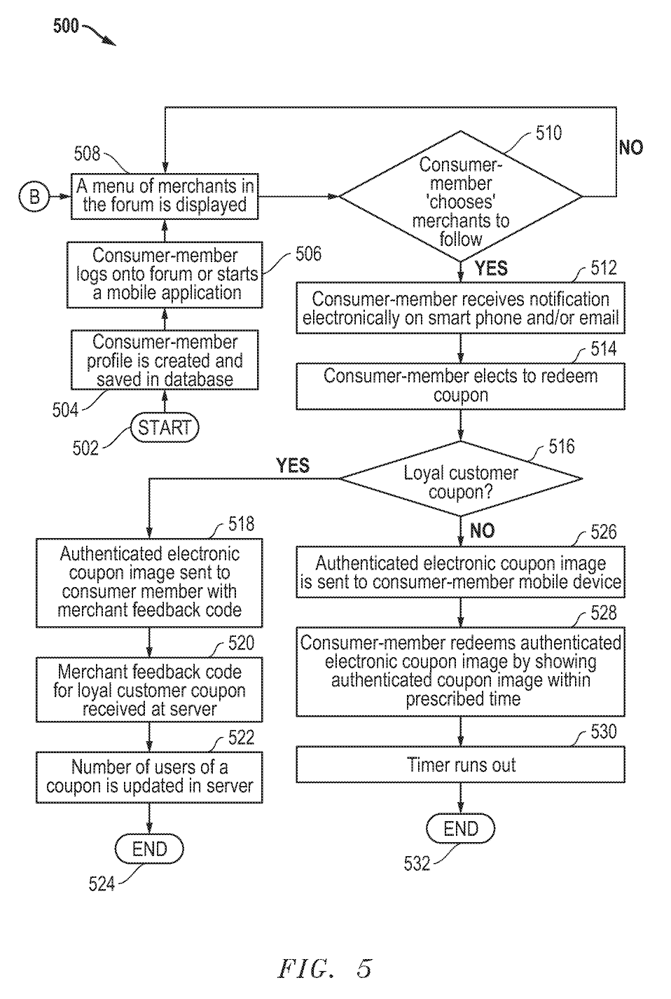

FIG. 5 shows a flow chart detailing a process 500 for becoming a consumer member and accessing merchant e-coupon offers. Process 500 also depicts the process for redeeming the e-coupon by the consumer member. The process 500 begins at 504 where a consumer member uses a form on his or her computer to create a consumer member profile. In an alternative embodiment, the consumer member may be required to pay a subscription fee to obtain consumer member status and access e-coupon offers. The subscription fee may be recurring, for example, monthly, annually or in some other recurring time period. Payment status may be stored with the consumer member profile. At 506, when a consumer member logs onto a merchant forum via the internet or starts a mobile application to access the merchant forum system, data is received by the set of servers hosting the merchant forum indicating the same. This access identifies the consumer member by his or her unique identification number so that the consumer member's profile is readily available in the merchant forum system database. In response, at 508 of the described embodiment 500, display data is sent to the computer or mobile device of the consumer member to display the menu of merchants in the merchant forum. The display data includes any available e-coupons offered by the merchant. As shown and discussed with respect to FIG. 2, the menu of merchants 200 may also provide merchant profiles or links 230 to the same permitting the consumer member to gain more detailed information about the merchant. In an alternative embodiment, if a consumer attempts to access or redeem an e-coupon but has not subscribed, the merchant forum system will prompt the consumer to subscribe in order to get the e-coupon discount.

At 510, the consumer member may elect to obtain VIP status with a particular merchant. For example, the consumer member may elect to do this by selecting a VIP status button 250, shown in FIG. 2 as associated with the merchant he or she chooses to follow. The VIP status button appears on the merchant forum menu displaying e-coupon images of FIG. 2 or may appear on a profile page for the merchant. Alternatively, the VIP status button 250 may appear on the e-coupon offer itself.

Upon electing the VIP status button 250, or alternatively a VIP icon, data indicating the selection of VIP status is sent back to the set of servers hosting the merchant forum. The data identifies the consumer member by his or her assigned identification number. The merchant forum system updates the consumer members profile to indicate the election of VIP status for the selected merchant. The VIP consumer member identification number is associated with the unique merchant identification number. In some embodiments, display data may be sent from the merchant forum system servers to the consumer member's mobile device or computer system indicating VIP status has been accepted. As depicted in 512, the consumer member will receive future electronic notifications on his or her mobile device or via email or other electronic method. The electronic notifications indicate when the merchant with whom the consumer member has elected VIP status issues a new e-coupon offer.

At 514, the consumer member can elect to redeem a particular e-coupon offered by a merchant. This redemption can be any type of e-coupon whether it is a VIP specific e-coupon, an ordinary consumer member e-coupon, or a loyal customer e-coupon. The consumer member must have the appropriate status to redeem the particular type of e-coupon.

Upon receipt of the redemption intent data by the merchant forum system or upon receipt of validation of the redemption intent data, the merchant forum system determines the type of e-coupon that is being redeemed by the consumer member. At 516, the merchant forum system determines whether the e-coupon type is a loyal customer e-coupon. If not, in response to receipt of the redemption intent data or the validation of the same, the merchant forum system sends an authenticated electronic e-coupon image to the consumer member's mobile device 526. At 528, the consumer member redeems the authenticated e-coupon image by showing it—with the moving portion—to the merchant within the prescribed time. At 530 of the described embodiment, the timer at the merchant forum system runs out.

If the e-coupon to be redeemed is a loyal customer e-coupon, the servers hosting the merchant forum system may implement a slightly different authentication process, as shown in FIG. 5. Similar to 526, at 518 an authenticated e-coupon image is sent to a consumer member with a moving portion as described for 526, however, the authenticated e-coupon image must include some type of merchant feedback option 518. This can be in a form of a unique merchant feedback code, a type of displayed barcode, or other electronic indication suggesting a unique authenticated e-coupon image was displayed to the merchant. In the described embodiment at 520, the merchant feedback code is provided and the merchant feedback code is input by the merchant into a computer. Alternatively, a merchant code may be entered into the consumer member mobile device. In another embodiment, loyal customer feedback data is transmitted to the merchant forum system hosted on the set of servers in the network. When the unique code or other information indicating the loyal customer e-coupon redemption is received at 520, the merchant forum system logs the redemption to give credit to the consumer member for that particular redemption and purchase episode. Upon achieving a certain number of redemptions, the consumer member may be entitled to a featured offer or e-coupon deal. The featured e-coupon deal may be redeemed showing an authenticated e-coupon image with a moving portion or countdown limit as described above. In other words, the featured loyal customer e-coupon deal may be redeemed without merchant feedback data input to the merchant forum system.

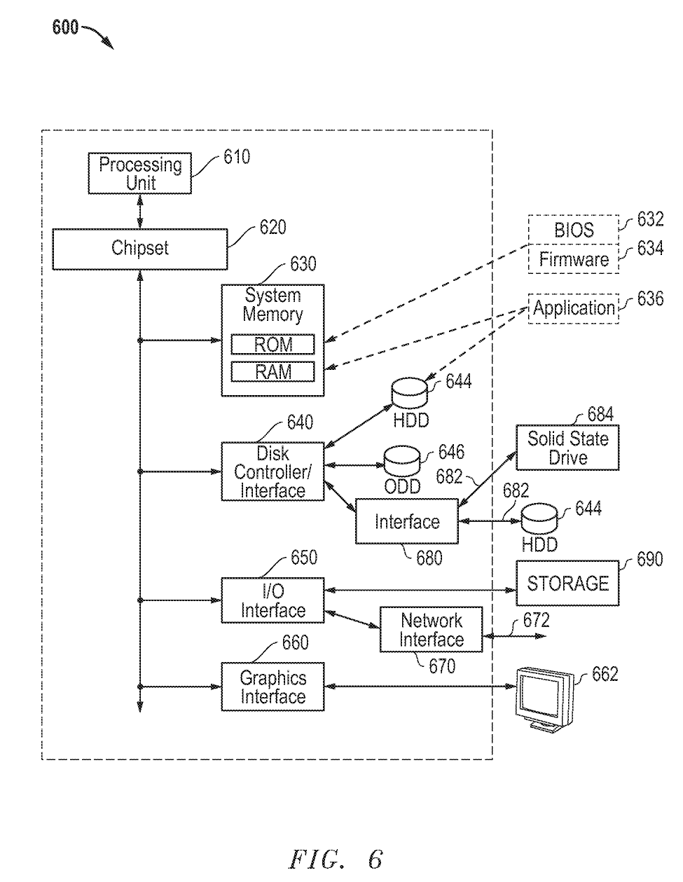

FIG. 6 is a block diagram illustrating an embodiment of a computer or server system 600, including a processing unit 610, a chipset 620, a system memory 630, a disk controller/interface 640, an input/output (I/O) interface 650, graphics interface 660, and a network interface 670. In a particular embodiment, the computer or server system 600 is used to carry out one or more of the methods described herein. In another embodiment, one or more of the computer or server systems described herein are implemented with a storage database to host the merchant forum system and carry out the methods described herein.

Chipset 620 is connected to processing unit 610 via a bus or other channel, allowing the processing unit to execute machine-executable code. In a particular embodiment, computer or server system 600 may include one or more processing units. Chipset 620 may support the multiple processing units and permit the exchange of data among the processing units and the other elements of the computer or server system. A bus or other channel permits the system to share data among the processing unit, the chipset, and other elements of computer or server system 600.

System memory 630 is connected to chipset 620. System memory 630 and chipset 620 can be connected via a bus or other channel to share data among the chipset, the memory, and other elements of computer or server system 600. In another embodiment, processing unit 610 may be connected to system memory 630. A non-limiting example of system memory 630 includes static random access memory, dynamic random access memory, non-volatile random access memory, read only memory, flash memory, or any combination thereof.

Disk controller/interface 640 is connected to chipset 620. Disk controller/interface 640 and chipset 620 can be connected via a bus or other channel to share data among the chipset, the disk controller, and other elements of computer or server system 600. Disk controller/interface 640 is connected to one or more disk drives. Such disk drives may include an internal or external hard disk drive (HDD) 644, and an optical disk drive (ODD) 646, and can include one or more disk drives as needed or desired. ODD 646 can include a Read/Write Compact Disk (R/W-CD), a Read/Write Digital Video Disk (R/W-DVD), a Read/Write mini Digital Video Disk (R/W mini-DVD), another type of optical disk drive, or any combination. Additionally, disk controller 640 is connected to disk interface 680. Disk interface 680 permits a solid-state drive 684 or external HDD 644 to be coupled to a computer or server system 600 via an external interface 682. External interface 682 can include industry standard busses such as a Universal Serial Bus (USB), IEEE-1394 Firewire, or other proprietary or industry-standard busses. Solid-state drive 684 can alternatively be disposed within the computer or server system 600. Any of the above drivers, individually or in combination, may save as the database storage for the merchant forum system. Alternatively, network links may connect to off-site memory or storage devices to save data as part of a merchant forum system database.

I/O interface 650 may include an I/O controller and is connected to chipset 620. I/O interface 650 and chipset 620 can be connected via a bus or other channel to share data among the chipset, the I/O interface, and other elements of computer or server system 600. I/O interface 650 is connected to one or more peripheral devices via possible intermediate channels and devices. Peripheral devices can include devices such as including a keyboard, mouse, or storage systems 690, graphics interfaces, network interface cards 670, sound/video processing units, or other peripheral devices. Network interface 670 includes one or more network channels 672 that provide an interface between the computer or server system 600 and other devices that are external to computer or server system 600. This includes an interface between the computer or server system 600 that may host the merchant forum system and various wired and wireless networks connected to the mobile devices or computers of consumer members and merchants for executing the methods and system described herein.

Graphics interface 660 is connected to chipset 620 via a bus or other channel which permits exchange of data among the chipset, the graphics interface, and other elements of computer or server system 600. Graphics interface 660 is connected to a video display 662.

Computer or server system 600 includes Basic Input/Output System (BIOS) 632 and firmware code 632, and one or more application programs 636. BIOS code 632 functions initializes the computer server system 600 on power up to launch an operating system, and to manage input and output interactions between the operating system and the other elements of the computer or server system. In a particular embodiment, the BIOS 632 and firmware code 634 and application programs 636 are stored in memory 630. The BIOS code 632, firmware 634, and application programs 636 include machine-executable code that is executed by processing unit 610 to perform various functions of computer or server system 600. In another embodiment, the BIOS code 632, firmware 634, and application programs 636 are stored in another storage medium of computer or server system 600. The BIOS code 632, firmware 634, and application programs 636 can each be implemented as single programs, or as separate programs to implement the methods and merchant forum system described herein. The machine executable code used to execute the computer implemented method steps and create the merchant forum system described herein are examples of application programs 636 in the described embodiments.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The numerous innovative teachings of the present application will be described with particular reference to the exemplary embodiments. However, it should be understood that this class of embodiments provides only a few examples of the many advantageous uses of the innovative teachings herein. In general, statements made in the specification of the present application do not necessarily limit any of the various claimed inventions. To the contrary, the description of the exemplary embodiments are intended to cover alternative, modifications, and equivalents as may be included within the spirit and scope of the invention as defined by the claims. Moreover, some statements may apply to some inventive features but not to others.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A computer-implemented method comprising:
receiving, at a server, redemption-intent data indicating that a consumer member requests to redeem an electronic coupon;
storing the redemption-intent data into a database and uniquely associating the electronic coupon with the consumer member;
setting a limit of a number of redemptions of the uniquely-associated electronic coupon to be one or more redemptions; and
sending, from the server to a consumer's mobile device, display data for an authentic electronic coupon image secured by displaying a moving image portion.

2. The method of claim 1, wherein the method further comprises sending display data from the server capable of displaying a count of redemptions associated with the uniquely associated electronic coupon.

3. The method of claim 1, wherein the method further comprises starting a timer to limit the amount of time permitted to redeem the authentic electronic coupon image.

4. The method of claim 1, wherein the method further comprises sending the authentic coupon display data from the server whereupon display of the authentic electronic coupon image will have a moving portion that comprises a moving border.

5. The method of claim 1, wherein the method further comprises sending the authentic coupon display data from the server whereupon display of the authentic electronic coupon image will have the moving image portion that comprises a count-down timer.

6. The method of claim 1, wherein the method further comprises receiving, from a merchant computer system, data verifying redemption of the uniquely associated electronic coupon by the consumer member.

7. The method of claim 1, wherein the method further comprises logging the number of redemptions of the electronic coupon in the database.

8. The method of claim 1, wherein the method further comprises sending the authentic coupon display data from the server to display an authenticate button in the authentic electronic coupon image that alters the moving image portion.

9. A computer-implemented method comprising:
receiving, at a server, data input into a coupon template from a merchant;
creating, at the server, a custom coupon campaign for the merchant wherein the method further comprises:
accessing a customized list of consumer members who have chosen a VIP status to follow the merchant and to receive notification of electronic coupons;
sending notification of an available electronic coupon from the server to a consumer member on a customized list of consumer members who have chosen to follow the merchant;
receiving, at the server, redemption-intent data indicating that the consumer member requests to redeem the coupon;
storing the redemption-intent data into a database and uniquely associating the coupon with the consumer member;
setting a limit on a number of redemptions of the uniquely associated coupon to be one or more redemptions;
sending, from the server to a consumer's mobile device, an authentic electronic coupon image secured by displaying the coupon image with a moving image portion; and
starting a timer to limit the amount of time permitted to redeem the authentic electronic coupon image.

10. The method of claim 9, wherein the method further comprises sending, from the server, display data for displaying the moving image portion that comprises a count-down timer image for display on the authentic electronic coupon image to correspond with the timer limiting the amount of time permitted to redeem the electronic coupon.

11. The method of claim 9, wherein the method further comprises sending the authentic coupon display data from the server whereupon display of the authentic electronic coupon image will have a moving portion that comprises a moving border.

12. The method of claim 9, wherein the method further comprises receiving from the mobile device a request to reset the timer that limits the amount of time permitted to redeem the authentic coupon.

13. The method of claim 12, wherein the requests to reset are limited to a fixed number of requests.

14. The method of claim 9, wherein the method further comprises sending display data from the server after the timer has expired on the electronic coupon capable of displaying that the electronic coupon is no longer redeemable.

15. The method of claim 9, wherein the method further comprises sending, from the server, display data capable of displaying a menu of merchants offering electronic coupons and displaying an image of the electronic coupon associated with at least one merchant in the menu of merchants.

16. The method of claim 9, wherein the method further comprises sending, from the server, display data capable of displaying a menu of merchants offering electronic coupons wherein the display data sent after the timer has expired on the electronic coupon indicates that the electronic image of the coupon in the menu of merchants is no longer accessible.

17. The method of claim 9, wherein the method further comprises receiving, at the server, data indicating redemption of the coupon from the merchant and sending display data capable of indicating on the displayed electronic coupon image in the menu of merchants that the electronic coupon is no longer accessible.

18. The method of claim 9, wherein the method further comprises sending the authentic coupon display data from the server to display an authenticate button in the authentic electronic coupon image that alters the moving image portion.

19. A non-transitory computer readable medium comprising instructions to manipulate a processor, the instructions comprising instructions to:
receive redemption-intent data indicating that a consumer member requests to redeem an electronic coupon;
store the redemption-intent data into a database and uniquely associate the electronic coupon with the consumer member;
set a limit of a number of redemptions of the uniquely-associated electronic coupon to be one or more redemptions; and
send, to a consumer's mobile device, display data for an authentic electronic coupon image secured by displaying a moving image portion.

20. The computer readable medium of claim 19, wherein the instructions further comprise: instructions to send display data to display a count of redemptions associated with the uniquely associated electronic coupon.

21. The computer readable medium of claim 19, wherein the instructions further comprise: instructions to start a timer to limit the amount of time permitted to redeem the authentic electronic coupon image.

22. The computer readable medium of claim 19, wherein the instructions further comprise: instructions to send the authentic coupon display data whereupon display of the authentic electronic coupon image will have a moving portion that comprises a moving border.

23. The computer readable medium of claim 19, wherein the instructions further comprise: instructions to send the authentic coupon display data whereupon display of the authentic electronic coupon image will have the moving image portion that comprises a count-down timer.

24. The computer readable medium of claim 19, wherein the instructions further comprise: instructions to receive from a merchant computer system data verifying redemption of the uniquely associated electronic coupon by the consumer member.

25. The computer readable medium of claim 19, wherein the instructions further comprise: instructions to log the number of redemptions of the electronic coupon in the database.

26. The computer readable medium of claim 19, wherein the instructions further comprise: instructions to send the authentic coupon display data to display an authenticate button in the authentic electronic coupon image that alters the moving image portion.

27. A non-transitory computer readable medium comprising instructions to manipulate a processor, the instructions comprising instructions to:
receive data input into a coupon template from a merchant;
create a custom coupon campaign for the merchant wherein the instructions further comprise instructions to:
access a customized list of consumer members who have chosen a VIP status to follow the merchant and to receive notification of electronic coupons;
send notification of an available electronic coupon to a consumer member on a customized list of consumer members who have chosen to follow the merchant;
receive redemption-intent data indicating that the consumer member requests to redeem the coupon;
store the redemption-intent data into a database and uniquely associate the coupon with the consumer member;
set a limit on a number of redemptions of the uniquely associated coupon to be one or more redemptions;
send, to a consumer's mobile device, an authentic electronic coupon image secured by displaying the coupon image with a moving image portion; and
start a timer to limit the amount of time permitted to redeem the authentic electronic coupon image.

28. The computer readable medium of claim 27, wherein the instructions further comprise: instructions to send display data for displaying the moving image portion that comprises a count-down timer image for display on the authentic electronic coupon image to correspond with the timer limiting the amount of time permitted to redeem the electronic coupon.

29. The computer readable medium of claim 27, wherein the instructions further comprise: instructions to send the authentic coupon display data from the server whereupon the display of the authentic electronic coupon image will have a moving portion that comprises a moving border.

30. The computer readable medium of claim 27, wherein the instructions further comprise: instructions to receive from the mobile device a request to reset the timer that limits the amount of time permitted to redeem the authentic coupon.

31. The computer readable medium of claim 30, wherein the instructions further comprise: instructions to limit the requests to reset to a fixed number of requests.

32. The computer readable medium of claim 27, wherein the instructions further comprise: instructions to send display data from the server after the timer has expired on the electronic coupon capable of displaying that the electronic coupon is no longer redeemable.

33. The computer readable medium of claim 27, wherein the instructions further comprise: instructions to send display data capable of displaying a menu of merchants offering electronic coupons and displaying an image of the electronic coupon associated with at least one merchant in the menu of merchants.

34. The computer readable medium of claim 27, wherein the instructions further comprise: instructions to send display data capable of displaying a menu of merchants offering electronic coupons wherein the display data sent after the timer has expired on the electronic coupon indicates that the electronic image of the coupon in the menu of merchants is no longer accessible.

35. The computer readable medium of claim 27, wherein the instructions further comprise: instructions to receive data indicating redemption of the coupon from the merchant and sending display data capable of indicating on the displayed electronic coupon image in the menu of merchants that the electronic coupon is no longer accessible.

36. The computer readable medium of claim 27, wherein the instructions further comprise: instructions to send the display data to display an authenticate button in the authentic electronic coupon image that alters the moving image portion.
